(19) United States
(12) Patent Application Publication
(10) Pub. No.: US 2020/0219020 A1
(43) Pub. Date: Jul. 9, 2020

(54) SYSTEM AND METHOD OF STRUCTURING RATIONALES FOR COLLABORATIVE FORECASTING

(71) Applicant: HRL Laboratories, LLC, Malibu, CA (US)

(72) Inventors: Robert Giaquinto, St. Paul, MN (US); Tsai-Ching Lu, Thousand Oaks, CA (US); Aruna Jammalamadaka, Agoura Hills, CA (US); Ryan M. Uhlenbrock, Camarillo, CA (US)

(21) Appl. No.: 16/591,397

(22) Filed: Oct. 2, 2019

Related U.S. Application Data
(60) Provisional application No. 62/790,263, filed on Jan. 9, 2019.

(51) Int. Cl. G06Q 10/04; G06F 17/18; G06N 7/00; H04L 12/58

(52) U.S. Cl. CPC G06Q 10/04; H04L 51/046; G06N 7/005; G06F 17/18

(57) ABSTRACT

Described is a system for structuring rationales for collaborative forecasting between users of a crowdsourcing platform. For a given forecasting question, the system produces a forecasting rationale model from a combination of variables related to users and topics in a discussion of the users' forecasting rationale for making an initial forecast of an event. A relationship between the variables is determined, and based on the relationship between the variables, a prediction of each user's performance in making the initial forecast. Based on the predictions, top performing users and their forecasting rationales are selected, and the forecasting rationales of the top performing users are shared with other users of the crowdsourcing platform, allowing the other users to revise their initial forecasts in response to the shared forecasting rationales, resulting in revised forecasts. A forecast of the event that combines the revised forecasts is then output.

### CROSS-REFERENCE TO RELATED APPLICATIONS

This is a Non-Provisional application of U.S. Provisional Application No. 62/790,263, filed in the United States on Jan. 9, 2019, entitled, “A System and Methods of Structuring Rationales for Collaborative Forecasting,” the entirety of which is incorporated herein by reference.

### GOVERNMENT LICENSE RIGHTS

This invention was made with government support under U.S. Government Contract Number 2017-17061500006 awarded by IARPA. The government has certain rights in this invention.

### BACKGROUND OF INVENTION

### (1) Field of Invention

The present invention relates to a system for collaborative forecasting and, more particularly, to a system for collaborative forecasting that streamlines collaborating between participants of a crowd-sourcing platform.

### (2) Description of Related Art

Collaborative forecasting is the process for collecting and reconciling the information from diverse sources to generate a prediction. Crowdsourcing platforms relying on diverse, collective knowledge and have proven to be a reliable tool for forecasting (see Literature Reference No. 7 in the List of Incorporated Literature References). Hybrid Forecasting Competition (HFC) seeks to blend human intelligence in the form of crowdsourced forecasts with machine intelligence to make the most accurate predictions on geopolitical, macroeconomic, and world health events. Improving performance in the HFC carries considerable social benefits, namely, more reliable methods for predicting some of the challenging and consequential questions on the planet. A wealth of prior work exists on successfully employing machine learning for forecasting, but machine learning often requires training a different model for each forecast question. In the HFC, which contains over one hundred questions with more added weekly, preparing data and training a new model to each question is infeasible. Machine learning algorithms, however, are uniquely suited to supporting collaboration between forecasters. Supporting human forecasters benefits the system as whole in two ways. First, more collaboration creates more engaged and active participants. Second, reducing the cognitive load required to revise a forecast in light of other participant's rationales results in more accurate forecasts.

Previously discovered matrix factorization models have combined topic discovery to augment recommendation systems (RS) (see Literature Reference Nos. 3, 4, and 6 in the List of Incorporated Literature References). These approaches build user and item profiles based on observed outcomes (e.g., ratings given by a user for a movie, or accuracy of user on a forecast question). More recent techniques include side information (e.g., genre of movie, or domain of forecast question (see Literature Reference Nos. 2-4), or a topic model on side information specific to users or items (see Literature Reference Nos. 3, 4, and 6).

In the HFC data, each forecast made by a user on a question contains a rationale. The disadvantage of the prior art described above on data like these is that (1) they cannot model text occurring for each user and item pair in order to improve user and item profiles, and (2) none of the RS with topic models use a supervised approach to topic discovery and, therefore, cannot connect topics to arguments within a debate.

Thus, a continuing need exists for a system that can identify top-performing users and a side of an argument that they advocate for, and share their rational with other users.

### SUMMARY OF INVENTION

The present invention relates to a system for collaborative forecasting, and more particularly, to a system for collaborative forecasting that streamlines collaborating between participants of a crowd-sourcing platform. The system comprises one or more processors and a non-transitory computer-readable medium having executable instructions encoded thereon such that when executed, the one or more processors perform multiple operations. For a given forecasting question, the system produces a forecasting rationale model from a combination of a plurality of variables related to users and topics in a discussion of the users' for making an initial forecast of an event. A relationship is determined between the plurality of variables, and based on the relationship between the plurality of variables, a prediction of each user's performance in making the initial forecast is generated. Based on the generated predictions, the system selects top performing users and their forecasting rationales. The forecasting rationales of the top performing users are shared with other users of the crowdsourcing platform, thereby allowing the other users to revise their initial forecasts in response to the shared forecasting rationales, resulting in revised forecasts. A forecast of the event that combines the revised forecasts is output.

In another aspect, the plurality of variables comprises data related to users' forecasting abilities, data related to difficulty of individual forecasting problems (IFPs), and data related to the topics in the discussion of the users' forecasting rationale.

In another aspect, the system predicts how each user will perform on each IFP.

In another aspect, the system generates a plurality of user profiles and IFP profiles; models the topics in the discussion of the users' forecasting rationales in relation to the plurality of user profiles and IFP profiles; and learns more accurate user profiles from the users' forecasting rationales based on the modeling.

In another aspect, in producing the forecasting rationale model, the system causes topics in the discussion to align to varying sides of a two-side debate, wherein the forecasting rationales of the top performing users represent either side of the two-sided debate.

In another aspect, the forecasting rationale model is formulated as a probabilistic graphical model defining the relationship between the plurality of variables.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a system for collaborative forecasting according to some embodiments of the present disclosure;

FIG. 2 is an illustration of a computer program product according to some embodiments of the present disclosure;

FIG. 3 is an illustration of collaboration between users on prediction markets according to some embodiments of the present disclosure;

FIG. 4 is an illustration of the system design of the system for collaborative forecasting according to some embodiments of the present disclosure;

FIG. 5 is an illustration of a Probabilistic Matrix Factorization for Rationalized Forecasts (PMF-RF) model according to some embodiments of the present disclosure;

FIG. 6 is an illustration of forecasts shown for one question according to some embodiments of the present disclosure;

FIG. 7 is an illustration of topics and their alignment with respect to consensus opinion according to some embodiments of the present disclosure;

FIG. 8 is an illustration of latent embedding space of users according to some embodiments of the present disclosure;

FIG. 9A are tables illustrating a first and second set of notation and parameters used in the PMF-RF model according to some embodiments of the present disclosure;

FIG. 9B is a table illustrating a third set of notation and parameters used in the PMF-RF model according to some embodiments of the present disclosure;

FIG. 9C is a table illustrating a fourth set of notation and parameters used in the PMF-RF model according to some embodiments of the present disclosure;

FIG. 10 is a table illustrating root mean squared error (RMSE) calculations comparing the PMF-RF model with a baseline for varying latent dimensions according to some embodiments of the present disclosure;

FIG. 11 is a screenshot illustrating a crowdsourcing platform offering predicting exchanges on political and financial events according to prior art; and

FIG. 12 is a screenshot illustrating a crowdsourcing platform for forecasting world events according to prior art.

### DETAILED DESCRIPTION

The present invention relates to a system for collaborative forecasting, and more particularly, to a system for collaborative forecasting that streamlines collaborating between participants of a crowd-sourcing platform. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a list of cited references is provided. Next, a description of the various principal aspects of the present invention is provided. Finally, specific details of various embodiment of the present invention are provided to give an understanding of the specific aspects.

### (1) LIST OF INCORPORATED LITERATURE REFERENCES

The following references are cited and incorporated throughout this application. For clarity and convenience, the references are listed herein as a central resource for the reader. The following references are hereby incorporated by reference as though fully set forth herein. The references are cited in the application by referring to the corresponding literature reference number, as follows:
1. Andriy Mnih and Ruslan R Salakhutdinov. Probabilistic Matrix Factorization. In Advances in neural information processing systems, page 8, 2007.
2. Ian Porteous, Arthur Asuncion, and Max Welling. Bayesian Matrix Factorization with Side Information and Dirichlet Process Mixtures. In, AAAI, page 6, 2010.
3. Hanhuai Shan and Arindam Banerjee. Generalized Probabilistic Matrix Factorizations for Collaborative Filtering. In 2010 IEEE International Conference on Data Mining, pages 1025-1030, December 2010.
4. Deepak Agarwal and Bee-Chung Chen. fLDA: Matrix Factorization Through Latent Dirichlet Allocation. In WSDM, page 91. ACM Press, 2010.
5. Jon D. Mcauliffe and David M. Blei. Supervised Topic Models. In Advances in Neural Information Processing Systems, page 121-128, 2008.
6. Chong Wang and David M. Blei. Collaborative Topic Modeling for Recommending Scientific Articles. In KDD page 448. ACM Press, 2011.
7. Justin Wolfers and Eric Zitzewitz. Prediction markets. In Journal of Economic Perspectives 18(2), page 107-126, 2004.
8. Robert Giaquinto and Tsai-Ching Lu. Structuring Discussions for Collaborative Forecasting. Association for the Advancement of Artificial Intelligence, 2018.

### (2) Principal Aspects

Various embodiments of the invention include three “principal” aspects. The first is a system for collaborative forecasting. The system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

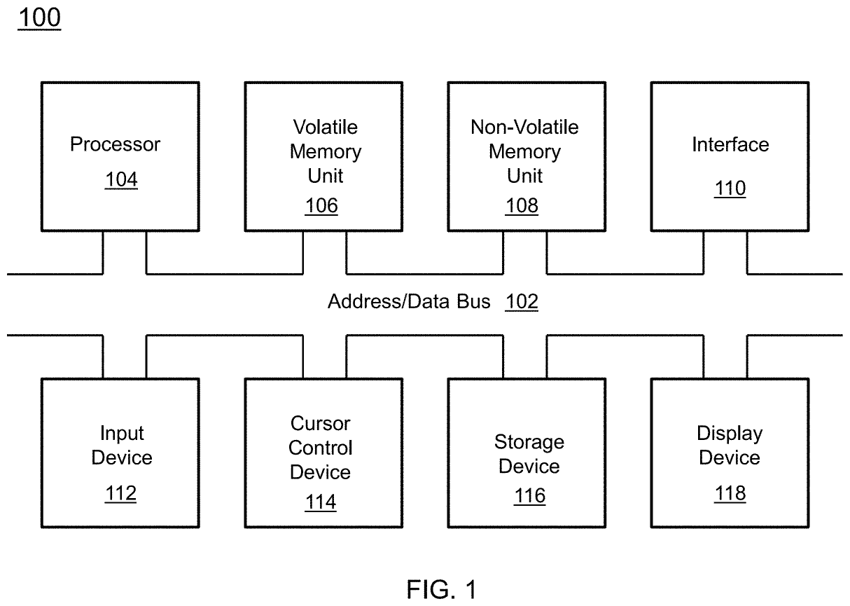

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

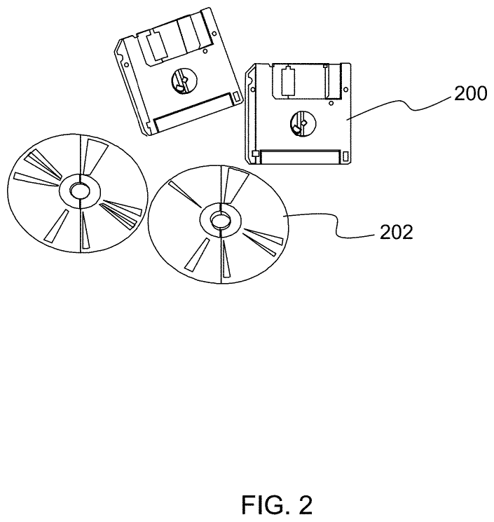

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

### (3) Specific Details of Various Embodiments

(3.1) Overview

Crowdsourcing platforms relying on diverse, collective knowledge have proven to be a reliable tool for forecasting. In order to support crowdsourcing participants, a unique probabilistic graphical model that learns the relationship between latent user profiles and the arguments made in each forecast rationale was developed and is described in detail below. The model is referred to as Probabilistic Matrix Factorization for Rationalized Forecasts (PMF-RF) after the collaborative filtering technique it extends. The invention described herein applies the PMF-RF model, creating a unique ability to identify quality rationale to show each user on each question, in order to create an autonomous feedback loop supporting participants on a crowdsourcing platform.

Significant research in combining human and machine intelligence focuses on crowdsourcing knowledge, that is, optimally combining forecasts by multiple humans into a single best forecast. Less attention has been paid to studying how machines can augment and support human forecasting through more efficient knowledge sharing and collaboration. The invention described herein strikes directly at improving collaboration between teams of humans forecasting a common question. When seeking crowdsourced knowledge it's important to avoid anchoring participants, that is, independent thought and analysis should be a focus when humans first attempt to create a forecast. After being given an opportunity for an independent analysis, collaboration can help humans to revise and improve their forecasts. In a large scale project such as HFC, however, it can be overwhelming for participants to consider every other participant's forecast. In order to promote collaboration between users, a method was developed that automatically structures discussions of forecasting rationale as two-sided debates with a top ranked rationale representing either side of the debate.

In order to address a large scale project, such as HFC, a solution is achieved by building a model of (1) user's forecasting abilities, (2) the difficulty of individual forecasting problems (IFPs), and (3) the topic's user's discuss in the rationale behind their forecasts. By understanding the relationship between these three variables, the model according to embodiments of the present disclosure predicts how well each user will perform on each IFP. In small data settings like HFC, the model learns much more about users through their rationale. This improved understanding of users' abilities can then be used to provide more accurate estimates of which users are likely to make strong arguments on either side of a debate.

A key to the invention's success lies in its ability to accurately profile users based on their rationale, but doesn't use rationale to directly predict user performance. This treatment of rationale allows the model to identify quality rationale on both sides of the debate even though only one side can be correct. Thus, after making an initial forecast a user can review other's arguments without facing information overload. Instead, the debate is presented with two clear sides of the argument and the top rationales on either side.

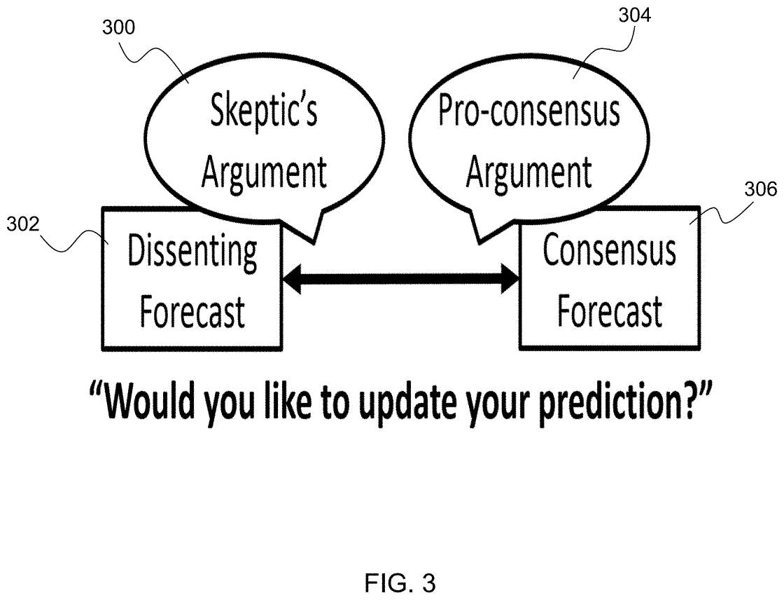

FIG. 3 depicts collaboration between users on prediction markets promoted by (1) simplifying discussions into two-sided debates, and (2) presenting the top ranking rationale on both sides of the debate. For instance, as shown in FIG. 3, one side of the debate is a skeptic's argument (element 300) and a dissenting forecast (element 302), and the second side of the debate is a pro-consensus argument (element 304) and a consensus forecast (element 306). Structuring the discussion and presenting clear arguments lowers the cognitive load on users, and allows them to efficiently analyze and revise their forecasts in response to other user's arguments.

The invention draws advantages over prior art from its technical novelty. Specifically, the invention extends existing recommendation system methodologies, taking advantage of the unique features of the HFC data. In particular, in addition to discovering participant and problem profiles, the algorithm models topics discussed in the forecasting rationale in relation to the profiles. As a result, the algorithm learns more accurate user profiles from their rationale. The advantage of this formulation is that it maximizes the limited information available and can detect quality arguments on both sides of a debate.

A primary advantage of the system and method described herein over existing technologies and approaches lies in the lower cognitive load placed on participants. Forecasting macroeconomic, geopolitical, and global health events requires broad knowledge and often additional research by the participants. Moreover, the forecasting questions on the HFC platform have varied response types (i.e., binary, multiple choice, or ordinal multiple choice, and participants must assign a probability to each answer). To ask a participant to collaborate and consider the arguments of another is too great, which is reflected by the fact that, in general, participants of some crowdsourcing platforms rarely revise or return to their original forecasts.

The invention described herein simplifies the collaboration step in two ways. First, the debate over the forecast is simplified into a two-side debate by posing rationale as either agreeing or disagreeing with the consensus opinion. Second, only arguments from the users who are most likely to provide correct forecasts are shared to users in order to reduce cognitive load. Framing the forecast debate as a two-sided argument, highlighting the top arguments on each side, lowers the cognitive load on participants by not requiring them to analyze every other participant's rationale. Additionally, the two-side debate setup encourages collaboration between participants because it only asks them to critically analyze one or two other rationales. The system and method according to embodiments of the present disclosure directly improves the platform by encouraging collaboration and lowering the cognitive load on participants attempting to revise their forecast in light of other participants rationales. These effects, in turn, have an advantageous effect on the overall system. First, encouraging collaboration leads to more engaged participants and, thus, more likely to keep using the system. Second, the invention simplifies and encourages revision of forecasts. By easing and encouraging thoughtful revision, the invention described herein improves overall forecasting accuracy of the system.

Human moderation of discussion forums is common and could be applied successfully on the forecasting platform. The system according to embodiments of the present disclosure, which is fully automated, curates the discussion by promoting certain forecast rationales to a place of high visibility. Due to biases, humans may favor certain participants or certain answers, and, thus, humans are not empirically optimal forecast discussion curators. The invention described herein, on the other hand, excels at predicting which participants can be trusted and computing which other participants may benefit from considering the trusted participant's rationale. Not only that, but the invention has the advantage of scalability; for each participant and question, the system computes which rationale will benefit the participant the most from seeing. To avoid biasing users, top rationales are shared only after a user makes an initial forecast.

(3.2) System Design

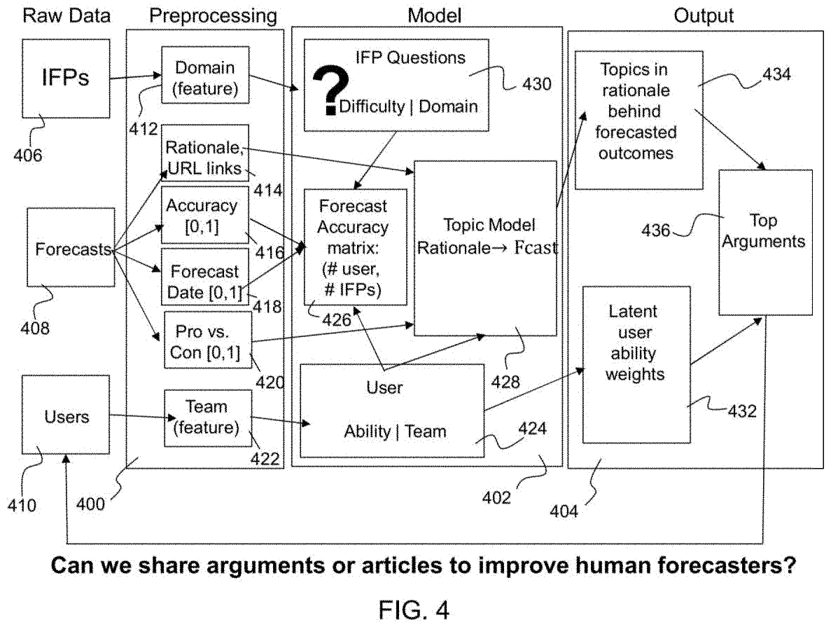

An overview of the invention is shown in FIG. 4, which identifies the three main steps behind the invention: data pre-processing and transformation (element 400), modeling (element 402), and post-processing (element 404). Input to the system comes in the form of raw data, including data from IFPs (element 406), data from forecasts (element 408), and data from users (element 410). IFPs (element 406) are processed to extract features related to the domain (element 412). IFPs may pertain to a number of diverse domains, non-limiting examples of which include upcoming election results, number of infected cases for a disease outbreak, and economic indices. By processing the data from forecasts (element 408), rationale, URL links (element 414), forecast accuracy (element 416), forecast date (element 418), and pro vs. con (element 420) information can be obtained.

User rationales are short text snippets that a user supplies with their forecast to explain their reasoning. The rationale for their forecast decisions may include URL links (element 414) which support their arguments. Therefore, the URL link is related to the IFP/domain. Forecast accuracy (element 416) (normalized from 0 to 1) is a measure of how close the forecast turned out to be to the actual realized value. For example, an IFP may ask for the value of a stock index two months from now. The forecast accuracy (element 416) of the submitted forecast is the distance from the realized value. This can only be calculated for past IFPs. The forecast date (element 418) is the date of the forecast normalized between 0 (date the IFP was issued) and 1 (date the IFP closed). For the IFP above, if a forecast was submitted one month in (out of the total of two months), then the forecast date would be 0.5. Pro vs. con (element 420) is a measure of which side of the two-sided debate this forecast fell on. The system simplifies the debate into two sides, and these are being referenced as “pro” and “con”. For example, if the majority of users felt the stock index (in the example above) would fall between values X1 and X2, that might be “pro” (pro-majority), whereas disagreements with this viewpoint would be “con”.

The data from users (element 410) is processed to obtain features related to the user's team (element 422), which is used to generate a user profile (element 424) with user information, user ability, and user team information. In the HFC program, users were assigned to teams of participants. Users could only see the rationales and forecasts of their own team members, and were encouraged to compete against other teams of users (e.g., via a leaderboard). In the system described herein, the team which a user was assigned to is used as a feature which is fed into the construction of their latent user profile.

This information, along with the accuracy data (element 416) and forecast date (element 418), are used to generate a forecast accuracy matrix (element 426) with elements including, but not limited to, number of users and number of IFPs. A supervised topic model (element 428) is generated from the user profile (element 424) and the rationale features (element 414). The supervised topic model (element 428) incorporates a user's forecast rationale as side-information for the PMF-RF model. The supervised topic model (element 428) chooses topics that vary in agreement with the consensus opinion on a question.

In post-processing (element 404), the model's insights are used to determine which forecasters (or users) are the most skilled and compute which rationales (element 414) should be shared back with each user. To implement the system described herein, raw data must be pre-processed (element 400), leaving accuracy scores (element 416) for each user on each of their forecasts, and features relevant to each user (element 410), IFP (element 406), and forecast (element 408). The accuracy score (element 416) models the accuracy of each forecast by user i on question j in order to understand which users do well on which questions. The platform categorizes each IFP question (element 430), which is then used to learn intercepts for the latent profiles for each question.

User or IFP intercepts, or biases, are computed from user or IFP (pre-processed) input data along with their latent profiles. If user or item features aren't provided (due to sparsity of the dataset), these biases are used. For more details, refer to the residual PPMP models described in Literature Ref. No. 3. Thus, a user's rationale behind their forecast is attached to their forecast. Additionally, each forecast has a timestamp which is transformed to determine timeliness of the forecast, computed as the percentage between when the forecast question opened and closed. A latent profile is a characterization of a user or IFP which is computed by the system described herein. For instance, given all input data for users and IFPs, the system classifies each user into one of N types of users, and each IFP into one of M types of IFPs. One type of user might be particularly poor at forecasting on economics questions. It is called a “latent” profile because it is determined by the system and is not immediately observable from the input data.

As shown in FIG. 4, the PMF-RF model (element 402) learns optimal latent profiles for each user and IFP that best explain the observed accuracy of each forecast (i.e., latent user ability profiles (element 432)). Further, the model's topic discovery component represents forecast rationale by themes running through them and the side of the argument taken by the user (i.e., topics in rationale behind forecasted outcomes (element 434)). After PMF-RF finds an optimal model of the data, the top arguments (element 436) on each side of the debate are extracted from the most skilled forecasters.

The PMF-RF is trained on the observed data, learning an optimal value for the latent profiles (element 432) and the effects of question category and forecast timeliness. The dimension size K of the latent profiles (element 432) and, equivalently, the number of topics discovered must be pre-specified. Larger values of K afford the model more flexibility at the cost of added computational complexity and risk of overfitting the data. Technical details on training the model are described below. However, from a high level the algorithm follows a Variational Expectation-Maximization approach. In the expectation step (E-step) the model finds the optimal values of local variables on a stochastic mini-batch of observations, such as a user profile or item's profile and topics within a forecast. In the maximization step (M-step), the local variables are accumulated to update global variables, such as coefficients capturing feature effects and the distribution over words of each topic. Expectation-Maximization is a standard procedure used to determine the optimal parameters for a parametric model based on observed data. In this case, the parameters to determine are those describing the user's latent profile, the IFP's (item's) latent profile, and the topics within a forecast. To do this, the pre-processed raw data (FIG. 4, 400, 406, 408, 410) is used. Note that the Variational E-M procedure used here has been specifically constructed to fit this problem.

Convergence of the model is tracked by computing its log-likelihood, and to compare models the root mean squared error (RMSE) is computed on a held-out batch of accuracy observations. Computing RMSE between what the model predicts a user's accuracy is and the true accuracy summarizes how well the model's latent profiles understand each user's abilities and each question's difficulty. Once the latent variables in the model are learned, the goal is to compute which users will benefit the most from seeing other user's rationales. This is inherently a prediction problem since the interest is in deploying these techniques in real-time, where the true accuracy of a forecast is unknown but the goal is to help user's improve their forecasts. At this stage, the solution of structuring the discussion as a two sided debate and presenting the top rationale on both sides is implemented.

(3.3) Model Training

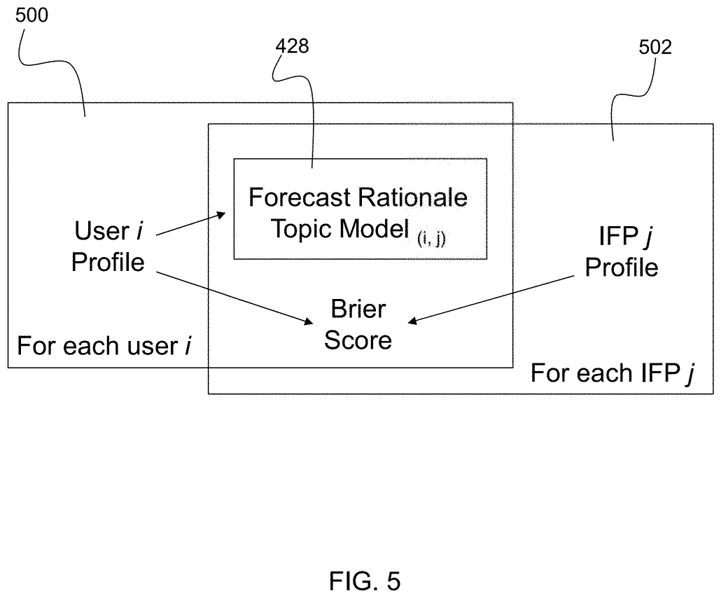

Traditional probabilistic matrix factorization (PMF) (see Literature Reference No. 1) is suited for dyadic data (user and item pairs). In the system according to embodiments of the present disclosure, the HFC data is transformed into a similar dyadic structure by computing the accuracy (element 414) of each user on each question for which they made a forecast (element 408). Then, a model, which posits accuracy to be a linear combination of each users and items' latent profile, along with side information on the user's team, item's category, and the date of each forecast, is generated. FIG. 5 depicts the structure of the PMF-RF model, which combines a user profile (element 500) for each user i with a IFP profile (element 502) for each IFP j. The user profile (element 500) approximates arguments made in the rationale. The user profile (element 500) and IFP profile (element 502), in turn, are used to compute a Brier score, which is a score function that measures the accuracy of probabilistic predictions.

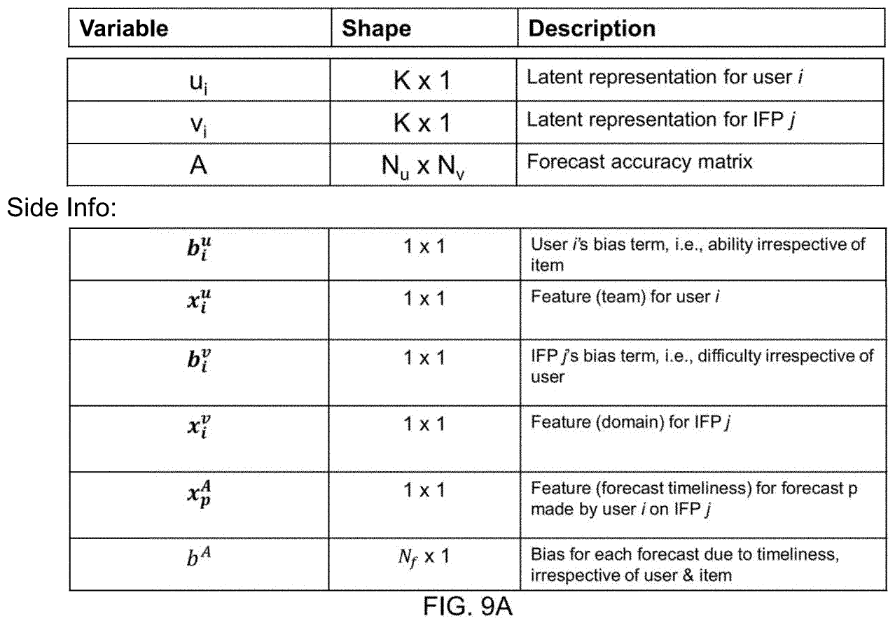

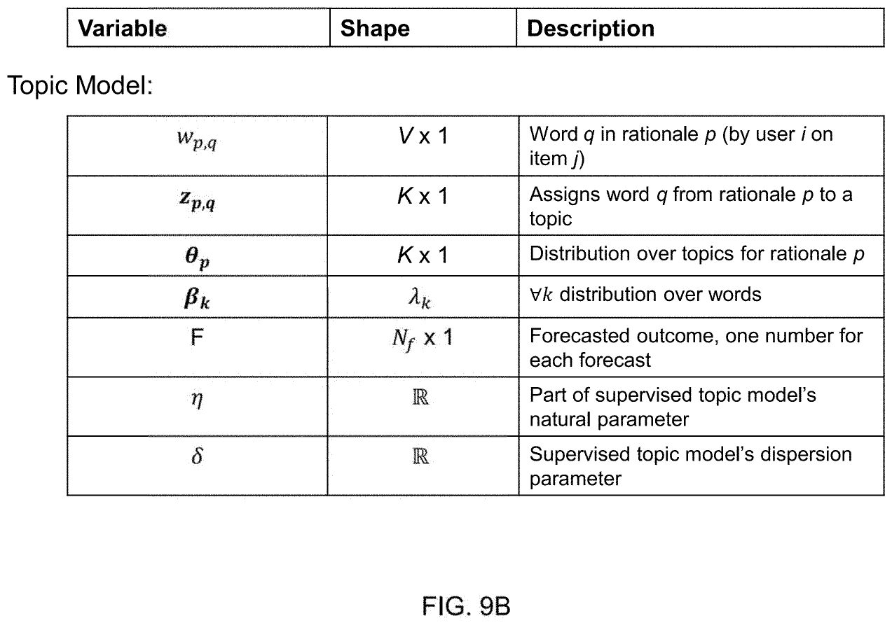

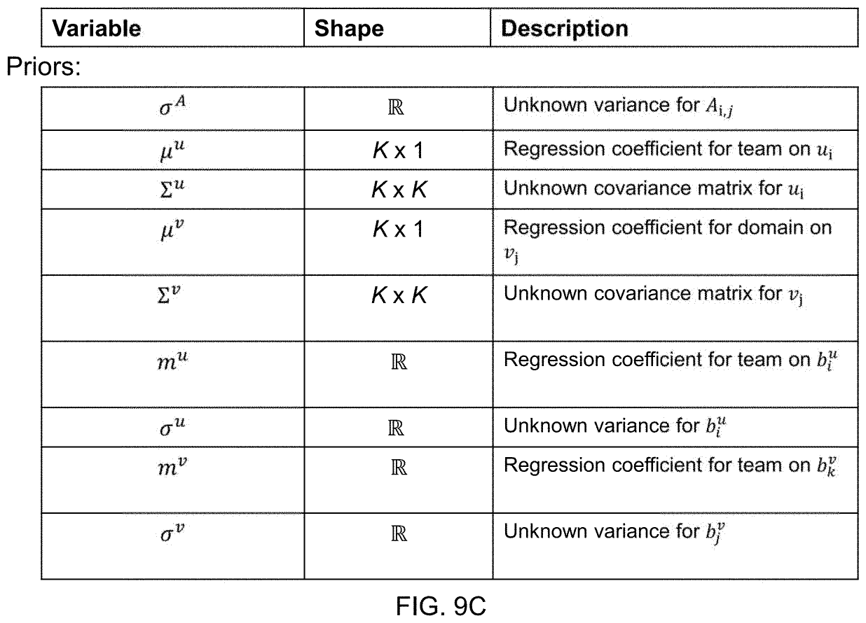

Unlike some matrix factorization approaches, the model described herein is formulated as a graphical model with Bayesian priors. The graphical model defines the relationships between variables and observed data. The relationships between variables is described below through the model's generative process. Descriptions of each variable listed in the generative process are given in the tables in FIGS. 9A, 9B, and 9C, which list notation and parameters used in the PMF-RF model. The unique parameterization for supervised topic modeling is used to discover topics discussed in forecast rationales.
1. For each user i observe feature xᵢ^{u}, and for items xⱼ^{v}, drawn uniformly random.
2. Generate user bias bᵢ^{u}˜ [symbol] (m^{uT}xᵢ^{u},v^{u}) for user i.
3. Generate user latent vector uᵢ˜ [symbol] (μ^{uT}xᵢ^{u}Σ^{u}).
4. Generate user bias bⱼ^{v}˜ [symbol] (m^{vT}xⱼ^{v},v^{u}) for user j.
5. Generate item latent vector vⱼ˜ [symbol] (μ^{vT}xⱼ^{v}Σ^{v}).
6. For each forecast p∈1, . . . , N_{f} made by user i for item j.
   a. Draw topic distribution θₚ˜ [symbol] (uᵢ,Σ^{u})
   b. For each word w_{q} where q∈1, . . . , N_{w}:
      i. Choose topic assignment z_{p,q}˜Multinomial (logistic(θₚ)).
      ii. Choose word w_{pq} from p(w_{p,q}|β_{z}_{_{q}}), a multinomial probability conditioned on the topic indicator z_{p,q}.
   c. Draw response variable Fₚ|[z_{p,1:N}_{_{w}},η,δ]˜GLM(z̅,η,δ) where

$$\overline{z} = \frac{1}{{N}_{w}} {\sum }_{q = 1}^{{N}_{w}} {z}_{p , q ,}$$

$$and$$

$$P ( {f}_{p} \vert {z}_{p , 1 : {N}_{w}} , η , δ ) = h ( {f}_{p} , δ ) e \dot{x} p ( \frac{( {η}^{⊤} \overline{z} ) {f}_{p} - A ( {η}^{⊤} \overline{z} )}{δ} )$$

where

$$h ( {f}_{p} , δ ) = \frac{1}{\sqrt{2 π δ}} exp ( \frac{- {f}_{p}^{2}}{δ} )$$

is the base measure, and A(η^{T}z̅)=(η^{T}z̅)²/2 is the GLM's log-normalizer (assuming fₚ is Gaussian).
7. For each non-missing entry in A_{i,j}, generate A_{i,j}˜ [symbol] (uᵢ^{T}vⱼ+bᵢ^{u}+bⱼ^{v}+bₚ^{AT}xₚ^{A},σ^{A}). Note, [symbol] refers to a multivariate normal, whereas [symbol] is a univariate normal. Additionally, logistic(⋅) refers to the logistic function defined by logistic(x)=exp(x)/Σⱼ exp (xⱼ), which is used to map the Gaussian random variable θₘ to the multinomial's parameter (which is constrained to [0,1]).

(3.4) Quantitative Results

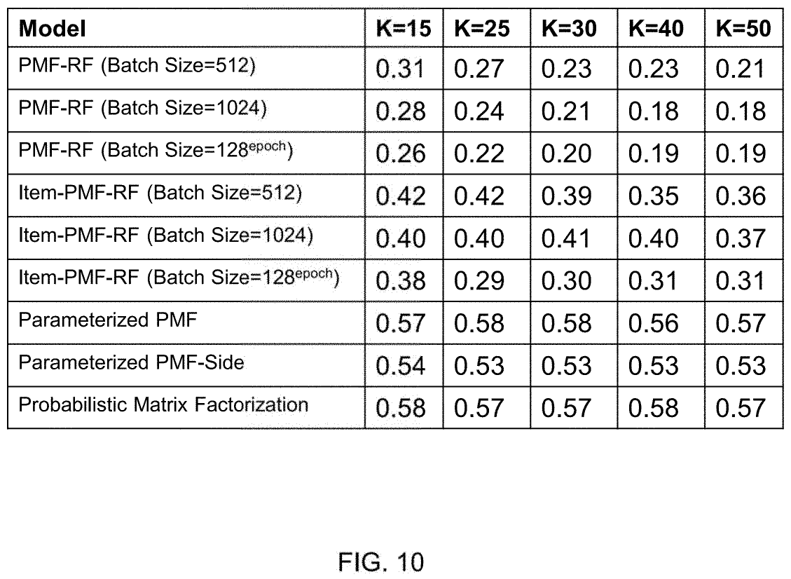

The table in FIG. 10 lists RMSE calculations for the method according to embodiments of the present disclosure and the baseline comparisons. In general, it was found that the method described herein outperforms comparable models. The mirror image of the model according to embodiments of the present disclosure, denoted Item-PMF-RF in the table, which uses the rationale to inform the latent item profiles (a more traditional approach) doesn't perform as well. The method can be trained with full batch gradients (as opposed to mini-batches); however, it was found that full batch training resulted in poor topic discovery. Mini-batch training results in more frequent Expectation-Maximization (EM) iterations, and hence topics can converge quickly, whereas full batch training progresses slowly following random parameter initializations. It was found, however, that using progressively larger batch sizes at each epoch results in both quickly converging topics and good generalizability in estimates of Brier scores.

(3.5) Qualitative Results

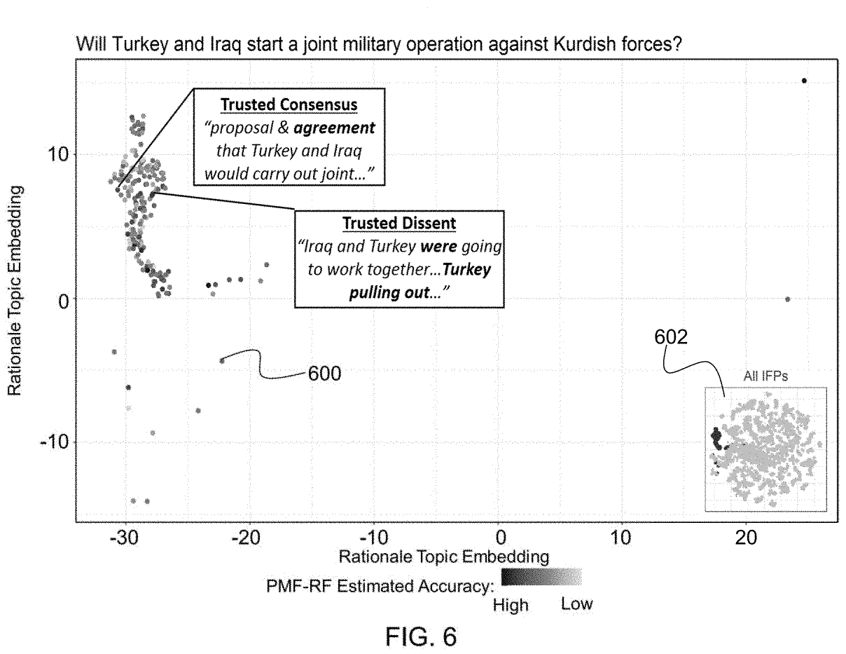

FIG. 6 depicts forecasts shown for one question. The position of data points (e.g., point (element 600)) corresponds to similarity of forecasting rationale, by projecting each rationale's topic proportions into two dimensions. A zoomed out view of all IFPs is shown in the box (element 602). FIG. 6 highlights an example of applying PMF-RF to select the top rationale on either side of the debate over whether Turkey and Iraq will form a joint military coalition against Kurdish forces. Here, the top ranked rationale paint a clear picture: the consensus opinion (which is incorrect) thought a coalition would form, however, the dissenting opinion notes that there was an agreement between the countries but Turkey backed out. While forecast rationale impacts computation of the user profile u, and, thus, the estimated Brier score, the model doesn't show strong discrimination based on the topic distribution of the rationale (as indicated by the position of each point). One likely explanation for this is that topics tend to capture major themes, and hence nuances in arguments can be lost. Unsurprisingly, outlier points from the primary mass/cluster tend to provide little rationale (e.g. “doesn't seem likely”) or much different argumentation (e.g. “deadline is eleven days away and nothing has happened yet”).

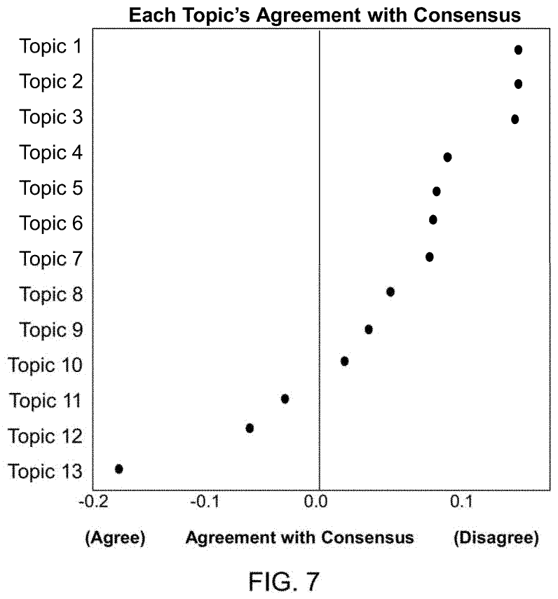

The primary purpose of the topic discovery component of the PMF-RF model is to guide the latent user profile u using information contained in the rationale. As opposed to a more traditional approach which models the text as item dependent, the approach described herein conditions topics discussed in each rationale on latent user profiles, thereby providing more information to an otherwise sparse estimate of each user. Topics also provide interesting qualitative analysis of the forecast discussions, allowing researchers to quickly zoom in or out on specific themes. FIG. 7 shows topics discovered by the supervised logistic-normal topic component within PMF-RF. Since each topic is aligned to a side of the argument (either agreeing with the consensus or not), the top five words are shown in a selection of election related topics discovered by the PMF-RF model (trained with K=50 topics). In general, it was found that most topics tend to focus on themes specific to individual questions (e.g., topics naming specific candidates in an election), while a few topics tend to capture more general argumentative themes (e.g., citing data, dates, rates, and trends). This is unsurprising given the variety of questions contained in the HFC dataset, and PMF-RF is trained with K<50.

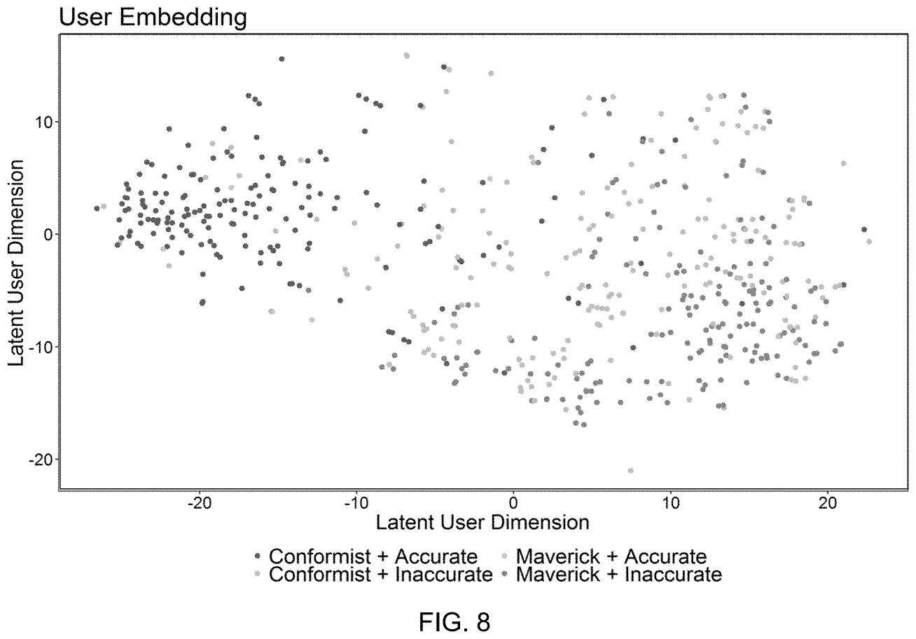

FIG. 8 depicts a user embedding plot, showing that the model correctly clusters users (represented by data points) who are generally accurate (average Brier score less than 0.3) separately from users who are on average less accurate. Each user (i.e., data point) is shaded according to whether they tend to agree with the consensus opinion or disagree, which further shows that the model picks up on these subtle differences in users. More specifically, FIG. 8 illustrates a latent embedding space of users, where the latent space was transformed from K=50 dimensions to two dimensions for visual purposes. Users are shaded according to their average performance and tendency to agree with the consensus. In general, the user embedding space tends to position users with similar performances and tendencies together. Users are coded as “mavericks” if they rank in the bottom third on average agreement of the consensus, and “conformists” otherwise. Users are labeled “accurate” if their average Brier score ranked in the top third of all users. Note, agreement with consensus does not factor timeliness. Hence, users may be coded as a “conformist” even if they were the first to make a particular forecast.

Previously discovered matrix factorization models have combined topic discovery to augment recommendation systems (RS) (see Literature Reference Nos. 3, 4, and 6). The system according to embodiments of the present disclosure extends on these methods, and displaces these methods in instances where text data exists for each user and item pair. The method described herein is designed for the one-of-a-kind structure of the HFC data. In particular, the model's topic discovery component is supervised, which causes the topics found to align to varying sides of the debate.

In addition to a unique model structure, the described method of transforming the data to perform the supervised discovery of topics within a debate is unique. Specifically, each user's forecast is mapped onto a scale of agreement with the consensus opinion. This approach makes discovering topics discussed within a debate broadly applicable in RS. For example, the model described herein can be applied to discover what users discuss when they like or dislike a consumer product, restaurant, or other, while simultaneously building a profile of user preferences.

A unique machine learning algorithm streamlines collaboration between participants of a crowd-sourcing platform for forecasting. By promoting arguments most likely to help each participant improve their forecast, the system described herein helps participants cut through the noise and quickly identify the key points to consider when answering a forecasting question. Because the invention is machine learning driven, it scales with the size of the platform without requiring human supervision.

The system according to embodiments of the present disclosure has several advantages. These include extending a traditional recommendation system and adapting it to a new domain: prediction markets. Another advantage is simplifying the discussion of a forecast between users by framing debate as two-sided with clear arguments on both sides. Yet another advantage is identifying top-performing users and the side of the argument they advocate for, and shares their rationale with other users. The invention described herein implements these three unique elements to create positive feedback loops of collaboration within the forecasting platform.

Reliable forecasting of political, macroeconomic, and global health events offers government valuable information that can lead to proper anticipation and planning for events having major global consequences. Machine learning offers a systemic approach for accurate forecasting of events for which there is good historical data to extrapolate from. For example, abundant data exists on oil prices, making it possible to train forecasting models. However, these models fail to anticipate the ripple effects of other global events, such as trade wars of military conflicts. Humans, on the other hand, are better adapted at anticipating the effects of such events. In an effort to combine the benefits of both human and machine forecasting, the Intelligence Advanced Research Projects Activity (IARPA) has funded the Hybrid Forecasting Competition (HFC), whose goal is to fund research on combining human and machine intelligence for forecasting.

The expected value of this solution is better performance on HFC, and a competition advantage by improving the quality of forecasts produced by the human participants. The invention described herein is unique in that it is designed specifically for the features and challenges associated with a crowdsourced forecasting platform. Data sparsity is a significant challenge for similar platforms because typically only a small percentage of the total participants answer each forecasting question. As a result, estimating which participants will be good at which question is non-trivial. Because the data's structure is defined by user-item pairs (e.g., a participant and a forecast question), prior art in this area treats this problem as a RS problem and applies collaborative filtering. In prior art for RS, the primary motivation isn't to model the text data accompanying each user-item pair. As described herein, however, modeling the relationship between forecast rationale and accuracy of the forecast is critical for identifying the best rationale to share back with other participants. Most importantly, the system according to embodiments of the present disclosure uses these algorithms to augment the user experience.

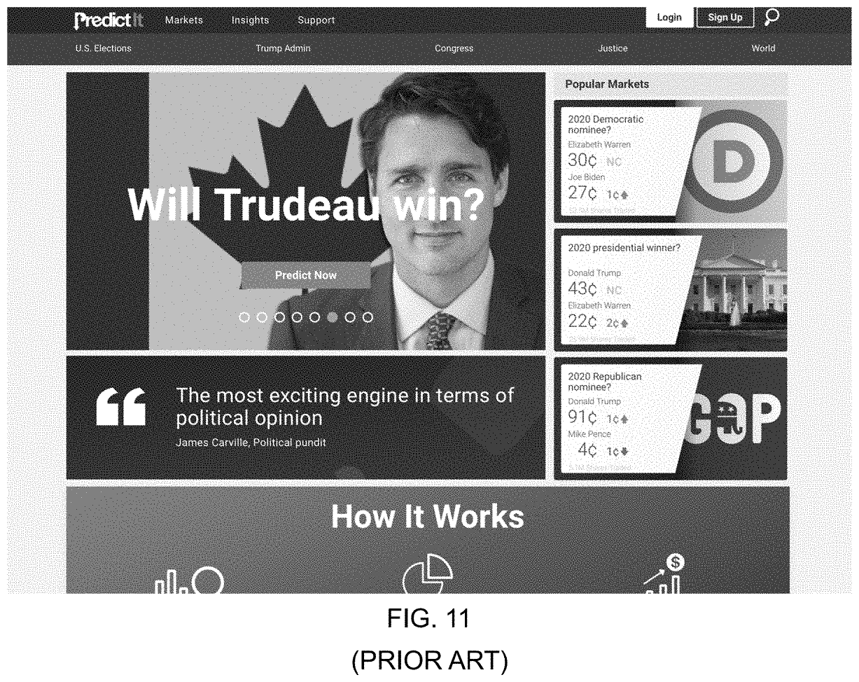

A non-limiting example of a crowdsourcing platform is PredictIt (URL: https://www.predictit.org), a screenshot of which is shown in FIG. 11. PredictIt is an experimental project owned and operated by Victoria University of Wellington. PredictIt is a prediction market website that offers prediction exchanges on political and financial events. Users make predictions by buying shares, where the price of the share corresponds to the market's estimate of the probability of an event taking place. Some markets feature questions have yes or no answers, and others have several possible outcomes. PredictIt includes a disclaimer that states that PredictIt does not monitor or assess the accuracy of comments.

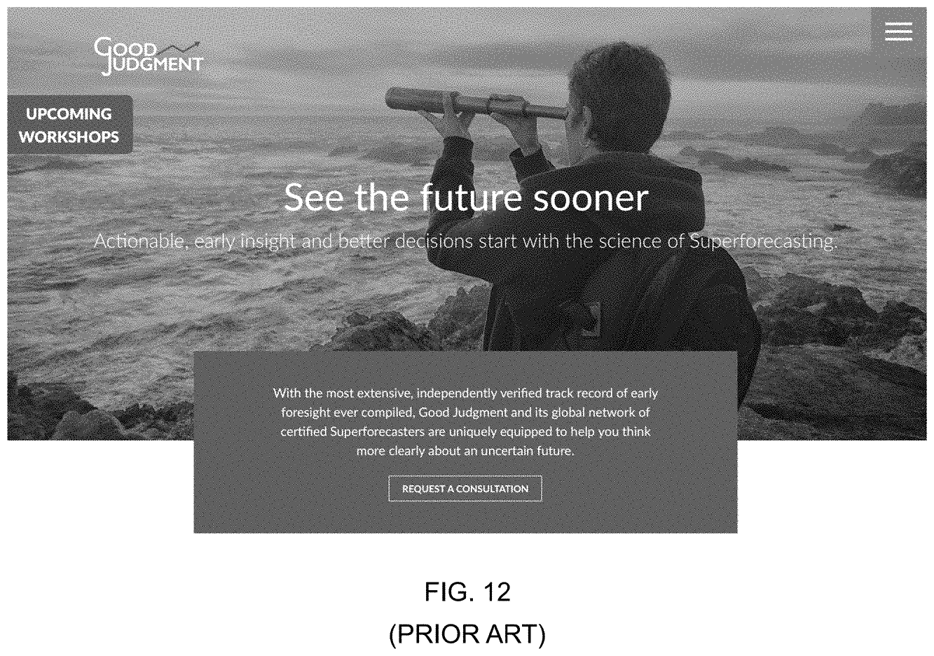

Another example of a crowdsourcing platform is the Good Judgement Project (URL:https://goodjudgement.com), a screenshot of which is shown in FIG. 12. The project uses a combination of statistics, psychology, training, and interactions between individual forecasts to produce forecasts of world events. A login must be created for this website, but once a user clicks on a particular question, the Good Judgement Project allows sorting by “Recent”, “Top” (most up-votes), “Following” (for users who have clicked the “follow” button for), and “With Links” (URLs which might link to useful information).

In both of the above examples, there is no intelligent sorting mechanism used by the crowdsourcing platforms. The present invention provides an improvement to existing crowdsourcing platforms used for forecasting events as users are presented with higher quality information on both sides of an argument. Thus, users will be able to make a more informed decision, enabling a crowdsourcing platform to be more accurate in its ability to forecast the correct answer. For example, if the given forecasting question in a crowdsourcing platform is the price of oil, the system and method described herein produces a forecasting rationale model related to variables related to users (e.g., user forecasting abilities) and discussion of oil prices, as described above. Based on the relationship between the variables, a prediction of each user's performance in making an initial forecast of the price of oil is generated. Based on the generated predictions, top performing users and their forecasting rationales for forecasting the price of oil are selected. The forecasting rationales of the top performing users are shared with other users of the crowdsourcing platform to influence the other users and allow them to revise their initial forecasts. The output is a forecast of the price of oil, for example, that will be more accurate than existing forecasting methods because it merges variables related to multiple users, and allows users to revise their initial forecasts after reviewing the rationales of top performing users.

In summary, this disclosure describes a unique probabilistic graphical model PMF-RF, tailored to the unique features of the HFC data. PMF-RF models the accuracy of users' forecasts, and includes a unique parameterization of the supervised topic model for discovering topics in the rationale behind each forecast. The topic discover component is supervised in order to align topics to sides of the debate. The forecasting debate is formulated as a two-sided, consisting of the consensus opinion and the dissenting opinion. PMF-RF then identifies the rationale most likely to be correct for both the pro-consensus and dissenting sides, which is shared back with users to simplify and encourage collaboration between users. The experimental results show that PMF-RF exceeds traditional PMF based approaches at predicting human forecasting performance.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. A system for structuring rationales for collaborative forecasting between users of a crowdsourcing platform, the system comprising:
one or more processors and a non-transitory computer-readable medium having executable instructions encoded thereon such that when executed, the one or more processors perform an operation of:
for a given forecasting question, producing a forecasting rationale model from a combination of a plurality of variables related to users and topics in a discussion of the users' forecasting rationale for making an initial forecast of an event;
determining a relationship between the plurality of variables;
based on the relationship between the plurality of variables, generating a prediction of each user's performance in making the initial forecast;
based on the generated predictions, selecting top performing users and their forecasting rationales;
sharing the forecasting rationales of the top performing users with other users of the crowdsourcing platform, thereby allowing the other users to revise their initial forecasts in response to the shared forecasting rationales, resulting in revised forecasts; and
outputting a forecast of the event that combines the revised forecasts.

2. The system as set forth in claim 1, wherein the plurality of variables comprises data related to users' forecasting abilities, data related to difficulty of individual forecasting problems (IFPs), and data related to the topics in the discussion of the users' forecasting rationale.

3. The system as set forth in claim 2, wherein the one or more processors further perform an operation of predicting how each user will perform on each IFP.

4. The system as set forth in claim 2, wherein the one or more processors further perform operations of:
generating a plurality of user profiles and IFP profiles;
modeling the topics in the discussion of the users' forecasting rationales in relation to the plurality of user profiles and IFP profiles; and
learning more accurate user profiles from the users' forecasting rationales based on the modeling.

5. The system as set forth in claim 1, where in producing the forecasting rationale model, causing topics in the discussion to align to varying sides of a two-side debate, wherein the forecasting rationales of the top performing users represent either side of the two-sided debate.

6. The system as set forth in claim 1, wherein the forecasting rationale model is formulated as a probabilistic graphical model defining the relationship between the plurality of variables.

7. A computer implemented method for structuring rationales for collaborative forecasting between users of a crowdsourcing platform, the method comprising an act of:
causing one or more processers to execute instructions encoded on a non-transitory computer-readable medium, such that upon execution, the one or more processors perform operations of:
for a given forecasting question, producing a forecasting rationale model from a combination of a plurality of variables related to users and topics in a discussion of the users' forecasting rationale for making an initial forecast of an event;
determining a relationship between the plurality of variables;
based on the relationship between the plurality of variables, generating a prediction of each user's performance in making the initial forecast;
based on the generated predictions, selecting top performing users and their forecasting rationales;
sharing the forecasting rationales of the top performing users with other users of the crowdsourcing platform, thereby allowing the other users to revise their initial forecasts in response to the shared forecasting rationales, resulting in revised forecasts; and
outputting a forecast of the event that combines the revised forecasts.

8. The method as set forth in claim 7, wherein the plurality of variables comprises data related to users' forecasting abilities, data related to difficulty of individual forecasting problems (IFPs), and data related to the topics in the discussion of the users' forecasting rationale.

9. The method as set forth in claim 8, wherein the one or more processors further perform an operation of predicting how each user will perform on each IFP.

10. The method as set forth in claim 8, wherein the one or more processors further perform operations of:
generating a plurality of user profiles and IFP profiles;
modeling the topics in the discussion of the users' forecasting rationales in relation to the plurality of user profiles and IFP profiles; and
learning more accurate user profiles from the users' forecasting rationales based on the modeling.

11. The method as set forth in claim 7, where in producing the forecasting rationale model, causing topics in the discussion to align to varying sides of a two-side debate, wherein the forecasting rationales of the top performing users represent either side of the two-sided debate.

12. The method as set forth in claim 7, wherein the forecasting rationale model is formulated as a probabilistic graphical model defining the relationship between the plurality of variables.

13. A computer program product for structuring rationales for collaborative forecasting between users of a crowdsourcing platform, the computer program product comprising:
computer-readable instructions stored on a non-transitory computer-readable medium that are executable by a computer having one or more processors for causing the processor to perform operations of:
for a given forecasting question, producing a forecasting rationale model from a combination of a plurality of variables related to users and topics in a discussion of the users' forecasting rationale for making an initial forecast of an event;
determining a relationship between the plurality of variables;
based on the relationship between the plurality of variables, generating a prediction of each user's performance in making the initial forecast;
based on the generated predictions, selecting top performing users and their forecasting rationales;
sharing the forecasting rationales of the top performing users with other users of the crowdsourcing platform, thereby allowing the other users to revise their initial forecasts in response to the shared forecasting rationales, resulting in revised forecasts; and
outputting a forecast of the event that combines the revised forecasts.

14. The computer program product as set forth in claim 13, wherein the plurality of variables comprises data related to users' forecasting abilities, data related to difficulty of individual forecasting problems (IFPs), and data related to the topics in the discussion of the users' forecasting rationale.

15. The computer program product as set forth in claim 14, wherein the one or more processors further perform an operation of predicting how each user will perform on each IFP.

16. The computer program product as set forth in claim 14, wherein the one or more processors further perform operations of:
generating a plurality of user profiles and IFP profiles;
modeling the topics in the discussion of the users' forecasting rationales in relation to the plurality of user profiles and IFP profiles; and
learning more accurate user profiles from the users' forecasting rationales based on the modeling.

17. The computer program product as set forth in claim 13, where in producing the forecasting rationale model, causing topics in the discussion to align to varying sides of a two-side debate, wherein the forecasting rationales of the top performing users represent either side of the two-sided debate.

18. The computer program product as set forth in claim 13, wherein the forecasting rationale model is formulated as a probabilistic graphical model defining the relationship between the plurality of variables.
